(19) United States
(12) Patent Application Publication
(10) Pub. No.: US 2026/0062111 A1
(43) Pub. Date: Mar. 5, 2026

(54) BOARDING LADDER SYSTEMS FOR AIRCRAFT

(71) Applicant: The Boeing Company, Arlington, VA (US)

(72) Inventor: Andrew James Hubbard, Saint Charles, MO (US)

(21) Appl. No.: 18/818,174

(22) Filed: Aug. 28, 2024

(51) Int. Cl. B64C 1/22

(52) U.S. Cl. CPC B64C 1/22

(57) ABSTRACT

Boarding ladder systems for aircraft are disclosed herein. An example boarding ladder of an aircraft includes a linkage including a first support, a platform, and a second support, the linkage rotatable in a first plane, a lateral stop arm of the first support to engage a catch of the platform in a deployed position, engagement of the lateral stop arm and the catch to restrict rotation of the linkage in a first direction of rotation, and a post pivotally coupled to the platform, the post rotatable in a second plane with respect to the platform, the second plane different than the first plane, the post including a fastener enabling coupling of the post and the first support in the deployed position.

### FIELD OF THE DISCLOSURE

This disclosure relates generally to aircraft and, more particularly, to boarding ladder systems for aircraft.

### BACKGROUND

Some aircraft (e.g., military aircraft, fighter jets, commercial aircraft, private jets, unmanned vehicles, etc.) require means to enable pilots, passengers, and/or maintenance personnel to access certain areas of the aircraft such as a cockpit, crew station, or upper surface of the air vehicle. Boarding ladders are one such means that enable users to reach such areas of the aircraft. Boarding ladders are either ground support equipment or part of the air vehicle that are internally stowed and not removed for flight.

### SUMMARY

A boarding ladder of an aircraft includes a linkage including a first support, a platform, and a second support, the linkage rotatable in a first plane, a lateral stop arm of the first support to engage a catch of the platform in a deployed position, engagement of the lateral stop arm and the catch to restrict rotation of the linkage in a first direction of rotation, and a post pivotally coupled to the platform, the post rotatable in a second plane with respect to the platform, the second plane different than the first plane, the post including a fastener enabling coupling of the post and the first support in the deployed position.

An aircraft includes a compartment to retain a boarding ladder, and a boarding ladder including a support assembly rotatable between a first position and a second position, the support assembly contained within the compartment in the first position, a portion of the support assembly extending outside of the compartment to an exterior of the aircraft in the second position, a first support of the support assembly including a lateral stop arm to engage a catch of a platform of the support assembly in the second position, and a post pivotally coupled to the platform, the post having a first state and a second state, the post oriented horizontally in the first state, the post oriented vertically in the second state, and the post fastened to a support of the support assembly in the second state.

A boarding ladder for a vehicle includes a support assembly to provide a first motion away from a surface of the vehicle, the support assembly including a first support including a lateral stop arm, and a platform coupled to the first support, the platform including a catch, the lateral stop arm to engage the catch at an end of the first motion, and a post coupled to the platform, the post to provide a second motion to rotate the post from a horizontal orientation to a vertical orientation.

### BRIEF DESCRIPTION OF THE DRAWINGS

FIG. 1 illustrates an example aircraft in which examples disclosed herein may be implemented.

FIG. 2 is a perspective view of an example boarding ladder system in a deployed and extended position, with the aircraft removed for clarity.

FIG. 3 is a front view of the example boarding ladder system of FIG. 2 in a collapsed and stowed position.

FIG. 4A is an enlarged perspective view of an example support assembly of the example boarding ladder system of FIG. 2.

FIG. 4B is an enlarged perspective view of an example lateral stop of the example boarding ladder system of FIG. 2.

FIG. 5A is a front view of an example folding step of the example boarding ladder system of FIG. 2 in an unfolded position.

FIG. 5B is a perspective view of an example top folding step of the example boarding ladder system of FIG. 2 in a folded position.

FIG. 5C is a front view of example bottom folding steps of the example boarding ladder system of FIG. 2 in a folded position.

FIG. 6A is a perspective, cutaway view of a portion of an example telescoping post that may be implemented by the example boarding ladder system of FIG. 2.

FIG. 6B is a perspective, cutaway view of the portion of the example telescoping post of FIG. 6A with example gland guides.

FIG. 6C is a perspective, cutaway view of the portion of the example telescoping post of FIG. 6B.

FIG. 7 is an example process for manufacturing example telescoping posts implemented by the example boarding ladder system of FIG. 2.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Boarding ladders that are carried by aircraft and stowed inside the aircraft during flight enable access to various areas of the aircraft from the ground without requiring external support equipment. Some known boarding ladders are vertically stored ladders that fold outward. Some known boarding ladder systems include a telescoping post in addition to flip-out or kick-in doors that provide the final steps of the system.

Other known boarding ladder systems are stored underneath a wing of the aircraft. Some existing boarding ladder systems store the ladder horizontally but require a significant amount of inboard-outboard space across the center of the aircraft. Some known boarding ladder systems include folding steps that require manual folding and unfolding of the steps.

Each of these known boarding ladder systems suffers from at least one of the following conditions: the system requires a large amount of vertical space on a surface of the aircraft to store the boarding ladder, the system requires flip-out, kick-in doors to provide the higher steps of the boarding ladder, the system consumes space in the wing of the aircraft, and/or the system requires a significant amount of space internal to the aircraft. Each of these conditions causes increased time to deploy, use, and/or store the boarding ladder, and/or imposes limitations on aircraft design due to amount of space required by, or the location of, the boarding ladder system.

Example apparatus and/or systems disclosed herein enable a boarding ladder to be stored horizontally and deployed vertically. Example boarding ladder systems disclosed herein include a support assembly to rotate away from a compartment of the aircraft and a telescoping post rotatably coupled to the support assembly to move the telescoping post from a horizontal orientation to a vertical orientation. Some example boarding ladder systems include a lateral stop arm, a catch, and pawls to prevent rotation of the support assembly when the boarding ladder is in a deployed position. Some example telescoping posts disclosed herein include a fixed step that extends above the compartment when the telescoping post is in the vertical orientation. Example boarding ladder systems disclosed herein utilize a bolt-action latch pin to fix the position of the telescoping post in the vertical orientation. Example telescoping posts disclosed herein include steps that automatically unfold in response to extension of the telescoping post and automatically fold in response to collapsing of the telescoping post. Example telescoping posts disclosed herein include gland guides to provide a mounting interface for the folding steps and provide a retention mechanism for telescoping post segments of the telescoping post. Example boarding ladder systems disclosed herein provide for a reduction in the space required to store a boarding ladder within an aircraft.

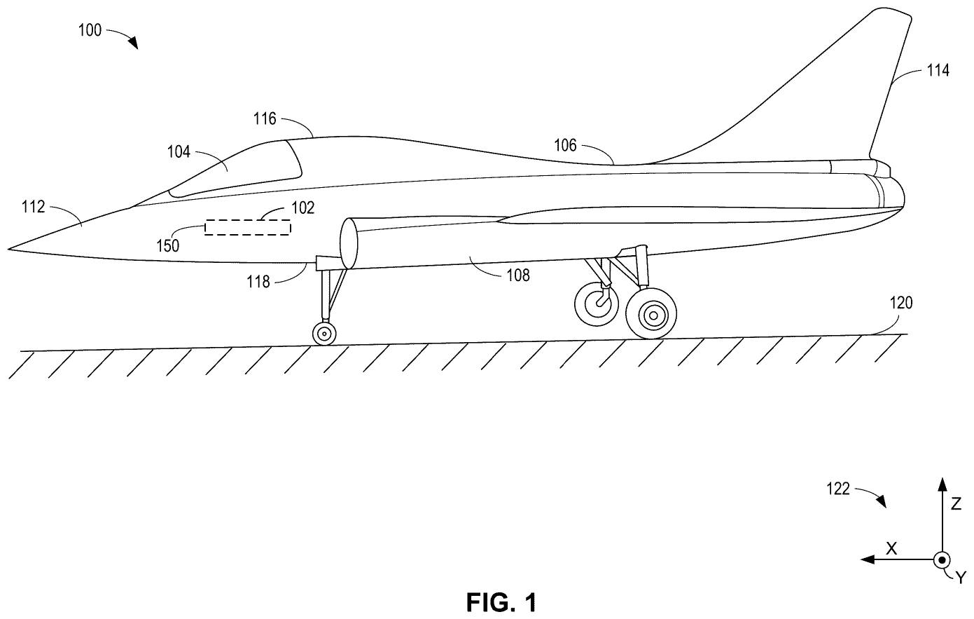

FIG. 1 illustrates an example aircraft 100 implemented with an example boarding ladder system 102. The aircraft 100 also includes a cockpit 104, a fuselage 106, a left wing 108, a right wing (not shown), a nose 112, a tail 114, an upper surface 116, and a lower surface 118. In the illustrated example of FIG. 1, the boarding ladder system 102 is stowed in a compartment 150 (e.g., internal bay) of the aircraft 100. The aircraft 100 is positioned on a surface 120. The boarding ladder system 102 is positioned below the cockpit 104 on a portion of the fuselage 106 on the left side of the aircraft 100. In some examples, the boarding ladder system 102 is positioned in another suitable location on the aircraft. In some examples, the aircraft 100 includes more than one boarding ladder system 102. The boarding ladder system 102 is moveable to a deployed and extended position, enabling a user on the surface 120 to climb the boarding ladder system 102 and reach areas of the aircraft 100 that the user could not reach without the boarding ladder system 102, such as, for example, the cockpit 104, the fuselage 106, the wings 108, and/or the upper surface 116. The boarding ladder system 102 is described in greater detail below.

Examples disclosed herein are discussed in connection with a cartesian coordinate system 122. An X-axis (e.g., a first axis) of the cartesian coordinate system 122 is parallel to the fuselage 106 of the aircraft 102 and extends between the nose 110 and the tail 112, a Y-axis (e.g., a second axis) is perpendicular to the X-axis and extends laterally across the wings 108 (e.g., into the page and out of the page in the orientation of FIG. 1) of the aircraft 100, and a Z-axis (e.g., a third axis) is perpendicular to both the X-axis and the Y-axis and extends vertically in the orientation of FIG. 1 between the upper surface 114 and the lower surface 116.

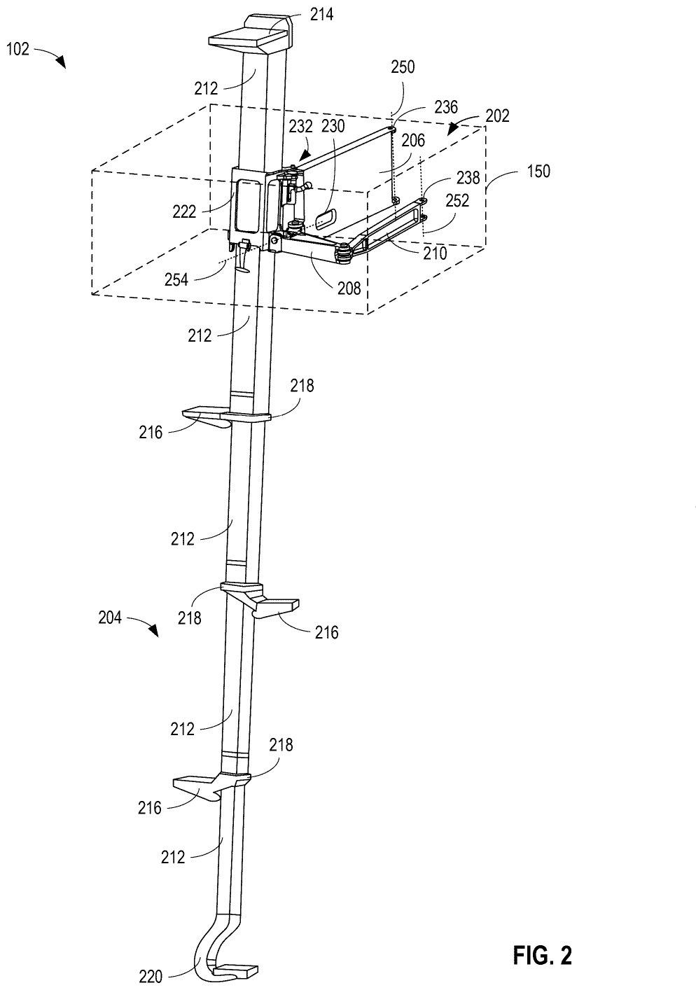

FIG. 2 is a perspective view of the example boarding ladder system 102 in a deployed position. The example boarding ladder system 102 includes a support assembly 202 and a telescoping post 204. The support assembly 202 includes a first support 206 (e.g., a primary support, a first link), a support platform 208 (e.g., a platform, a second link), and a second support 210 (e.g., a secondary support, a third link). As illustrated in FIG. 2, the first support 206 is pivotally fixed to the compartment 150 at a first location 236 and the second support is pivotally fixed to the compartment 150 at a second location 238. In some examples, the support assembly 202 is coupled to the compartment 150 in a manner different than what is illustrated in FIG. 2.

The support assembly 202 enables a first motion away from the aircraft 100. The first support 206, the support platform 208, the second support 210, and the compartment 150 form a four-bar linkage. In the illustrated example of FIG. 2, the support platform 208 is the coupler of the four-bar linkage. The four-bar linkage enables rotation of the support assembly 202 between a stored position (e.g., a first position) to an outwardly rotated position (e.g., a second position). The example first support 206 rotates about a first axis 250 at the first location 236. The example second support rotates about a second axis 252 at the second location 238. As such, the example support assembly 202 rotates in a first plane perpendicular to the first and second axes 250, 252. In other examples, the support assembly 202 rotates in a plane different than the first plane. When the support assembly 202 is in the stored position, both the support assembly 202 and the telescoping post 204 are retained (e.g. contained, held, stored, stowed) within the compartment 150. When the support assembly 202 is rotated to the outwardly rotated position, the telescoping post 204 is positioned outside the compartment 150 to an exterior of the aircraft 100.

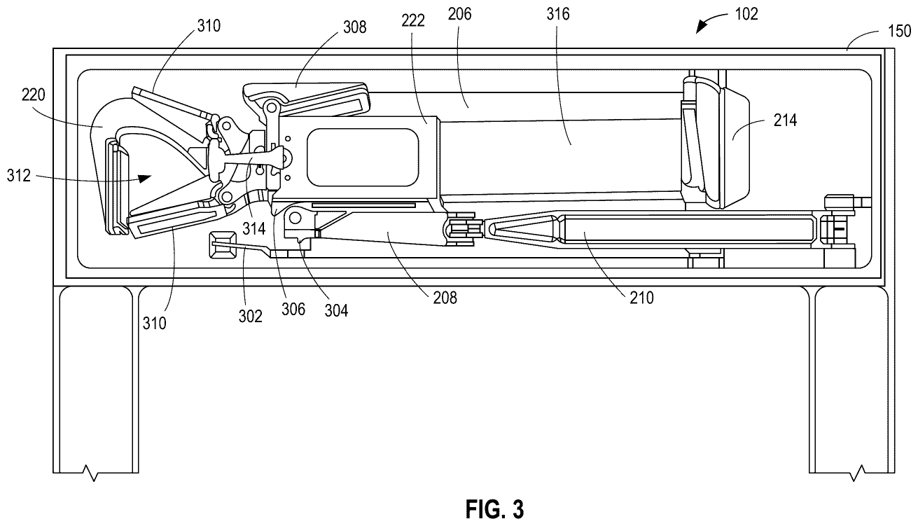

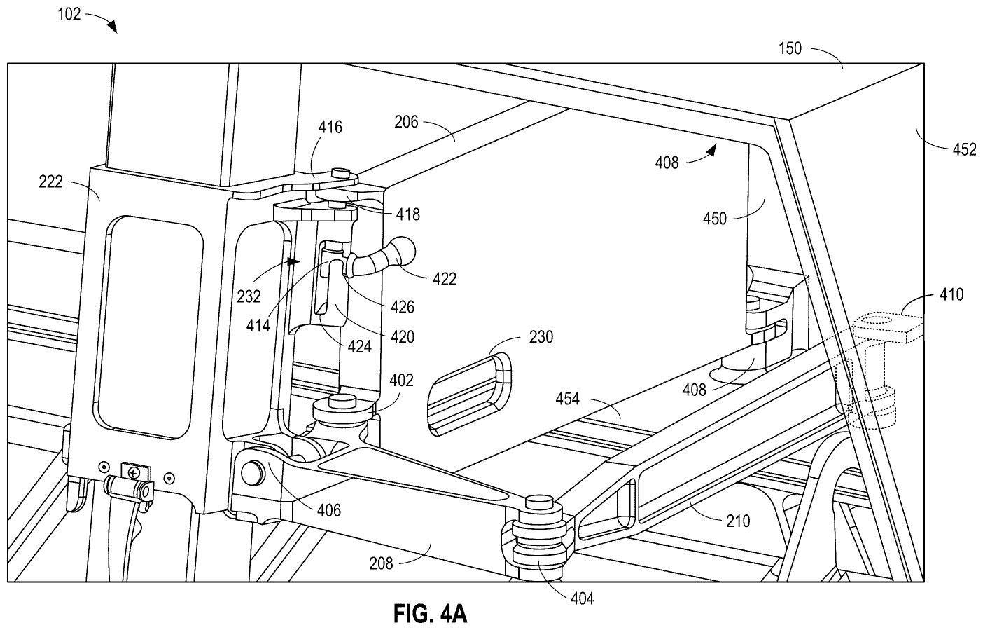

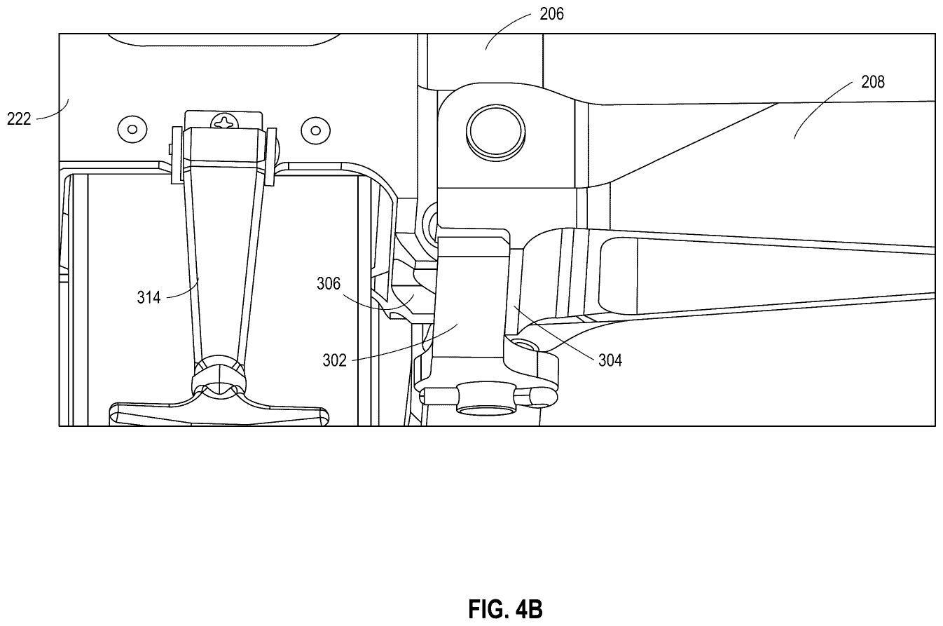

In some examples, the first support 206 includes a lateral stop arm 302 (shown in FIG. 3 and FIG. 4B) that engages a catch 304 (shown in FIG. 3 and FIG. 4B) of the support platform 208 at the end of the first motion. In other words, the lateral stop arm 302 engages the catch 304 when the support assembly 202 reaches the outwardly rotated position as shown in FIG. 2. Engagement of the lateral stop arm 302 and the catch 304 restricts rotation of the support assembly 202 in a first direction of rotation (e.g., the counter-clockwise direction of rotation in the first plane). In some examples, the support platform 208 implements a step.

In some examples, the first support 206 includes a recess 230. The recess 230 receives a fastening mechanism 232 of the telescoping post 204 when the boarding ladder 102 is in the stowed position. By receiving the fastening mechanism 232 of the telescoping post 204, the recess 230 enables stowage of the boarding ladder 102 in the compartment 150 having a depth dimension less than the depth of a compartment storing a boarding ladder 102 that does not include the recess 230. Furthermore, contact between the recess 230 and the fastening mechanism 232 of the telescoping post 204 restricts free movement of the boarding ladder 102 during flight. For example, the recess 230 may restrict movement of the boarding ladder 102 caused by vibration and/or negative G loading during flight.

The example telescoping post 204 includes a plurality of telescoping post segments 212 (e.g., nesting post segments), a top fixed step 214 (e.g., a first fixed step), a plurality of folding steps 216, a bottom fixed step 220 (e.g., a second fixed step), and an interface assembly 222. The telescoping post 204 is pivotally coupled to an end of the support platform 208 via the interface assembly 222. The pivotal coupling of the telescoping post 204 and the support platform 208 enables a second motion to rotate the telescoping post 204 from a first state to a second state. In the first state, the telescoping post 204 is in a horizontal orientation, in which the plurality of telescoping post segments 212 are substantially parallel to the support platform 208. The example telescoping post 204 rotates about a third axis 254 defined by the pivotal coupling of the telescoping post 204 and the support platform 208. As such, the telescoping post 204 rotates in a second plane perpendicular to the axis 254. As used herein, “substantially parallel” means exactly parallel or within 10 degrees of exactly parallel. As used herein, the telescoping post 204 being in a “horizontal orientation” means a length of the telescoping post 204 extends primarily in the direction of the X-axis in the plane defined by the X-axis and the Y-axis. In the second state, the telescoping post 204 is in a vertical orientation, in which the plurality of telescoping post segments 212 are substantially orthogonal to the support platform 208. As used herein, “substantially orthogonal” means exactly orthogonal or within 10 degrees of exactly orthogonal. As used herein, the telescoping post 204 being in a “vertical orientation” means the length of the telescoping post 204 extends primarily in the direction of the Z-axis. In both the first state and the second state, the telescoping post 204 is in a collapsed position.

As illustrated in FIG. 2, the top fixed step 214 extends above a top of the compartment 150 when the telescoping post 204 is oriented in the vertical orientation. This enables a user of the boarding ladder system 102 to reach a crew station and or top of the aircraft 100 where the available space for the compartment 150 for the aircraft 100 is limited, while avoiding complexity and structural weaknesses associated with upward telescoping posts. In some cases, the support platform 208 and the telescoping post 204 are positioned such that a bottom of the telescoping post 204 is angled away from the aircraft 100. For example, the telescoping post 204 may be offset from a perfectly vertical orientation by approximately 7 degrees. In some examples, the interface assembly 222 and the first support 206 provide a fastening mechanism to enable selective coupling of the interface assembly 222 to the first support 206 in the second state. The coupling of the telescoping post 204 to the first support 206 is discussed further in connection with FIG. 4A. The interface assembly 222 also includes lateral stop pawls 306 (shown in FIG. 3 and FIG. 4B) to engage the lateral stop arm 302 when the telescoping post 204 is in the vertical orientation. The pawls 306 restrict rotation of the support assembly 202 in a second direction of rotation that is opposite the first direction of rotation. The engagement of the pawls 306 and the lateral stop arm 302, and the engagement of the catch 304 and the lateral stop arm 302, restrict rotation of the support assembly 202 in both directions of rotation, fixing the boarding ladder system 102 in place.

The telescoping post 204 is moveable from the second state to a third state. In the third state, the telescoping post 204 remains in the vertical orientation and the plurality of telescoping post segments 212 are extended toward the surface 120. In some examples, the bottom fixed step 220 provides a gripping surface to enable a user to pull the plurality of telescoping post segments 212 down to extend the plurality of telescoping post segments 212 into the extended position. The example plurality of telescoping post segments 212 have square cross-sections. Square cross-sections provide improved anti-bending and anti-rotation benefits, as well as step-integration benefits. Square cross-sections also provide an increased strength-to weight ratio over other cross-sectional shapes and eliminate the need for a rotational key in the telescoping sections. In other examples, the plurality of telescoping post segments 212 have cross-sections that are circular, rectangular, triangular, or another geometric shape.

In response to the extension of the plurality of telescoping post segments 212, the plurality of folding steps 216 automatically unfold away from the plurality of telescoping post segments 212. Each one of the folding steps 216 is pivotally coupled to a respective one of the telescoping post segments 212 via a step bracket 218. Each of the plurality of folding steps 216 also includes a tension spring coupled to the respective step bracket 218. First ones of the plurality of folding steps 216 include respective followers that engage respective first cams from ones of the plurality of telescoping post segments 212 when the telescoping post segments 212 are collapsed. Engagement of the followers and the first cams causes the first ones of the plurality of folding steps 216 to fold against the tension springs to the folded position. Second ones of the plurality of folding steps 216 include respective bearing interfaces that engage ones of the plurality of telescoping post segments 212 when the telescoping post segments 212 are extended. Engagement of the bearing interfaces and the telescoping post segments 212 causes the second ones of the plurality of folding steps to unfold against the tension springs to the unfolded position.

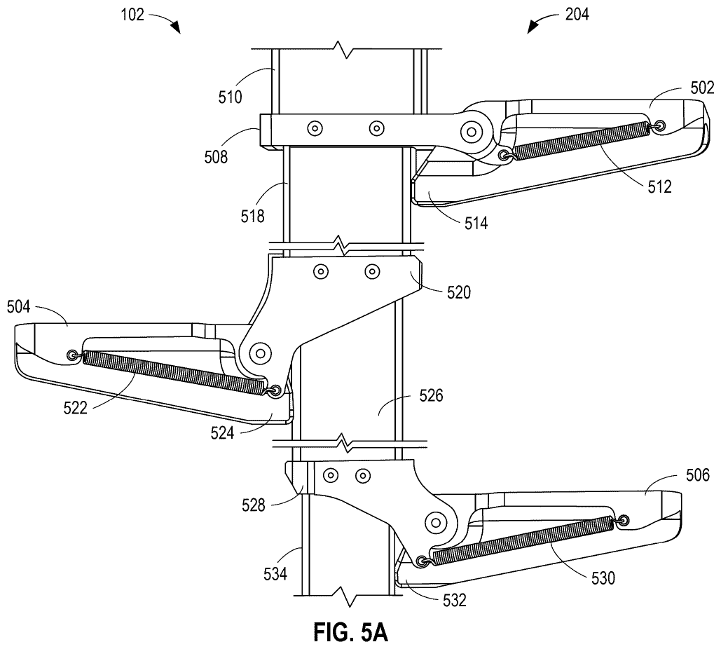

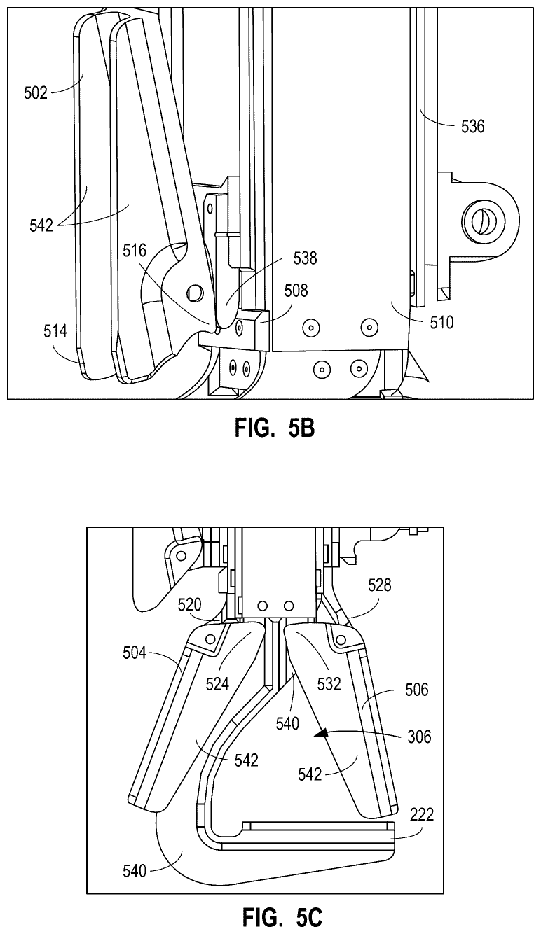

The automatic folding and unfolding of the plurality of folding steps 216 is discussed further in connection with FIGS. 5A-5C. When the telescoping post 204 is in the third state, the bottom fixed step 220, the plurality of folding steps 216, the support platform 208, and the top fixed step 214 provide surfaces for a user to climb the boarding ladder system 102 to access different areas of the aircraft 100.

FIG. 3 is a front view of the example boarding ladder system 102 in a collapsed and stowed position. In the collapsed and stowed position, the support assembly 202 is in the first position and the telescoping post 204 is in the first state. In the first position, the first support 206 is positioned along an interior surface of the compartment 150. The support platform 208 is also substantially parallel to the first support 206 in the first position. As a result, the length of the telescoping post 204 extends along an exterior surface of the aircraft 100 rather than into the body of the aircraft 100. As a result, the boarding ladder system 102 can be stored in the compartment 150 with minimal depth into the inner space of the aircraft 100. Furthermore, the length of the telescoping post 204 extends horizontally above the support platform 208 and the second support 210. As a result, the boarding ladder system 102 can be stored in a compartment 150 having a vertical dimension that is not constrained by the length of the telescoping post 204. The vertical dimension of the compartment 150 is instead related to the width of the telescoping post 204, a height of the top fixed step, and a height of the first support 206. In some examples, the compartment 150 has a vertical dimension equal to or less than approximately twice the width of the telescoping post 204. In the first state, the telescoping post segments 212 are collapsed (e.g., nested) such that the combined length of the telescoping post segments 212 is reduced compared to the combined length in the extended position. Thus, the amount of horizontal space required to store the boarding ladder system 102 is reduced.

As shown in FIG. 3, the lateral stop arm 302 does not engage the catch 304 or the pawls 306 in the collapsed and stowed position. When the support assembly 202 is rotated outwards, the lateral stop arm 302 engages the catch 304. When the telescoping post 204 is rotated to the vertical orientation, the lateral stop pawls 306 engage the lateral stop arm 302. This restricts rotation of the support assembly 202 in both directions of rotation, fixing the boarding ladder system 102 in place.

In the collapsed and stowed position, the plurality of folding steps 216 are in the folded position. As illustrated in FIG. 3, a first folding step 308 of the plurality of folding steps 216 folds upward along a side of the plurality of telescoping post segments 212. Second folding steps 310 of the plurality of folding steps 216 fold downward into a return cavity 312 of the bottom fixed step 220. By folding the first folding step 308 upward in the stowed position, the telescoping post 204 is able to carry an increased number of folding steps 216. The example telescoping post 204 also includes a draw latch 314 to lock the second folding steps 310 in place to limit movement of the second folding steps 310 when the boarding ladder system 102 is in the stowed position. The draw latch 314 also prevents the telescoping posts 212 from extending when the draw latch 314 is in use. In the illustrated example, the draw latch 314 is coupled to the interface assembly 222. In other examples, the draw latch 314 is coupled to a topmost telescoping post segment 316, or another portion of the telescoping post 204. In some examples, the draw latch 314 is a common latch. In some examples, the draw latch 314 includes a rubber handle that acts as a tensions spring. These features of the support assembly 202, in combination, enable complete internal storage of the boarding ladder system 102 within the compartment 150 without requiring interfaces outside of the compartment 150.

FIG. 4A is an enlarged perspective view of the boarding ladder system 102 in the outwardly rotated and extended position. The example first support 206 is a plate-like structure. In the illustrated example of FIG. 4A, the first support 206 is pivotally coupled to the support platform 208 via a first pivot joint 402. The first pivot joint 402 allows for rotation of the first support 206 and the support platform 208 relative to each other in the X-Y plane. In the illustrated example of FIG. 4A, the support platform 208 is pivotally coupled to the second support 210 via a second pivot joint 404. The second pivot joint 404 allows for rotation of the support platform 208 and the second support 210 relative to each other in the X-Y plane. The example interface assembly 222 of the telescoping post 204 is pivotally coupled to the support platform 208 via a third pivot joint 406. The third pivot joint 406 allows for rotation of the telescoping post 204 relative to the support platform 208 in the Y-Z plane. As illustrated in FIG. 4A, the first support 206 is pivotally coupled to a back wall 450 of the compartment 150 via first fixed pivot joints 408. The first fixed pivot joints 408 allow for rotation of the first support 206 relative to the back wall 450 in the X-Y plane. Likewise, the second support 210 is pivotally coupled to a side wall 452 of the compartment 150 via a second fixed pivot joint 410. The second fixed pivot joint 410 allows for rotation of the second support 210 relative to the side wall 452 in the X-Y plane. In other examples, at least one of the first support 206 and the second support 210 is coupled to a different interior surface of the compartment 150. For example, the second support 210 may be pivotally coupled to a bottom surface 454 of the compartment 150.

In the illustrated example, each of the first pivot joint 402, the second pivot joint 404, the third pivot joint 406, the first fixed pivot joints 408, and the second fixed pivot joint 410 is a bolted joint. Each of the first pivot joint 402, the second pivot joint 404, the third pivot joint 406, the first fixed pivot joints 408, and the second fixed pivot joint 410 includes a pin extending through a clevis or lug of the first pivotally coupled member and a clevis or lug of the second pivotally coupled member. The first pivot joint 402 includes a pin extending through a clevis of the first support 206 and a lug of the support platform 208. The second pivot joint 404 includes a pin extending through a clevis of the support platform 208 and a lug of the second support 210. The third pivot joint 406 includes a pin extending through a clevis of the interface assembly 222 and a clevis of the support platform 208. Each of the first fixed pivot joints 408 includes a pin extending through a lug of the first support 206 and a clevis of the back wall 450. The second fixed pivot joint 410 includes a pin extending through a lug of the second support 210 and a clevis of the side wall 452.

In other examples, at least one of the first pivot joint 402, the second pivot joint 404, the third pivot joint 406, the first fixed pivot joints 408, and the second fixed pivot joint 410 includes alternative combinations of clevises and lugs between the first pivotally coupled member and the second pivotally coupled member. For example, the first pivot joint 402 may include a pin extending through a lug of the first support 206 and a clevis of the support platform 208. In other examples, at least one of the first pivot joint 402, the second pivot joint 404, the third pivot joint 406, the first fixed pivot joints 408, and the second fixed pivot joint 410 is another type of pivot joint, such as a ball and socket joint.

The interface assembly 222 and the first support 206 provide a fastening mechanism (e.g., a fastener) 232 to enable selective coupling of the interface assembly 222 to the first support 206. In the illustrated example of FIG. 4A, the fastening mechanism 232 includes a bolt action latch pin (e.g., pin) 414 and clevis 416 of the interface assembly 222, and a lug 418 of the first support 206. In other examples, the interface assembly 222 and the first support 206 provide a different fastening mechanism, such as a draw latch. Once the telescoping post 204 is rotated into the second state, the pin 414 and the clevis 416 are lined up with the lug 418. In some examples, the pin 414 includes a long chamfer to accommodate for misalignment between the pin 414 and the lug 418. The bolt-action latch pin 414 includes a spring (not shown) and a slotted guide 420 that, in combination, ensure that the bolt-action pin 414 stays in the correct position. The spring biases the pin 414 downward. In some examples, the spring is a compression spring. In other examples, the spring is a tension spring. A bolt handle 422 provides a gripping surface for a user to move the pin 414 between a first position 424 and a second position 426 of the slotted guide 420. For example, when the telescoping post 204 is in the second state, the user can use the bolt handle 422 to move the pin 414 from the first position 424 to the second position 426 by moving the pin 414 upward and to the right within the slotted guide 420. In the second position 426, the pin 414 extends through the clevis 416 and the lug 418, as shown in FIG. 4A. The force from the spring retains the pin 414 in the second position 426. In some examples, the bolt handle 422 of the pin 414 folds against a side of the first support 206 when the pin 414 is in the second position 426. This reduces the likelihood of inadvertent movement of the pin 414 from engaged to disengaged. To move the telescoping post 204 back to the first state, the user can move the pin 414 to the first position 424 by moving the pin 414 upward and to the left within the slotted guide 420. In the first position 424, the pin 414 does not extend through the clevis 416 and the lug 418, allowing the telescoping post 204 to rotate back to the first state. The force from the spring retains the pin 414 in the first position 424.

In the illustrated example, the first pivot joint 402 is located at a bottom end of a side of the first support 206 and the fastening mechanism 232 is located at a top end of the side of the first support 206. This arrangement ties the telescoping post 204 into the first support 206 with a large moment arm between the first pivot joint 402 and the fastening mechanism 232, providing enhanced structural support about the primary bending axes, Mx and My, while the torsion axis Mz is supported by the second support 210 in an axial load across its section. In other examples, at least one of the first pivot joint 402 and the fastening mechanism 232 is located on a different portion of the first support 206. The bolt-action pin 414 directly supports the top fixed step 214, providing additional stiffness required for an upward cantilevered platform such as the top fixed step 214.

In the illustrated example of FIG. 4A, the interfaces between the telescoping post 204 and the support assembly 202 are all on the interface assembly 222. In other examples, one or more of the interfaces between the telescoping post and the support assembly 202 are located elsewhere on the telescoping post 204. The example interfaces assembly 222 is separate from the telescoping post segments 212. In other examples, the interface assembly 222 is integral to the topmost telescoping post segment 316.

FIG. 4B is another enlarged perspective view of the boarding ladder system 102 in the outwardly rotated and extended position. The first support 206 includes a lateral stop arm 302 that engages a catch 304 of the support platform 208 at the end of the first motion. In other words, the lateral stop arm 302 engages the catch 304 when the support assembly 202 reaches the outwardly rotated position as shown in FIG. 4B. Engagement of the lateral stop arm 302 and the catch 304 restricts rotation of the support assembly 202 in a first direction of rotation (e.g., the counter-clockwise direction of rotation in the first plane).

FIG. 5A is a front view of the example plurality of folding steps 216. The plurality of folding steps 216 are in the unfolded position in FIG. 5A. The plurality of folding steps 216 include a top folding step 502 (e.g., a first folding step), a middle folding step 504 (e.g., a second folding step), and a bottom folding step 506 (e.g., a third folding step). The top folding step 502 is pivotally coupled to a first step bracket 508. The first step bracket 508 is connected to a first telescoping post segment 510. A first tension spring 512 couples the top folding step 502 and the first step bracket 508, biasing the top folding step 502 in the unfolded position. The top folding step 502 further includes a first bearing interface 514 and a follower 516 (shown in FIG. 5B). In the unfolded position, the first bearing interface 514 is in contact with a second telescoping post segment 518. The second telescoping post segment 518 supports the moment force experienced by the first step bracket 508 when a user steps on the top folding step 502. The second telescoping post segment 518 also prevents the tension from the first tension spring 512 from pulling the top folding step 502 beneath the first telescoping post segment 510. Thus, in the unfolded position, the top folding step 502 provides a stable stepping surface that returns to the unfolded position if inadvertently moved by a user climbing the ladder.

The middle folding step 504 is pivotally coupled to a second step bracket 520. The second step bracket 520 is connected to the second telescoping post segment 518. A second tension spring 522 couples the middle folding step 504 and the second step bracket 520, biasing the middle folding step 504 in the folded position. The middle folding step 504 further includes a second bearing interface 524. In the unfolded position, the second bearing interface 524 is in contact with a third telescoping post segment 526, supporting the moment force experienced by the second step bracket 520 and preventing the tension from the second tension spring 522 from pulling the middle folding step 504 beneath the second telescoping post segment 518. Thus, in the unfolded position, the middle folding step 504 provides a stable stepping surface that returns to the unfolded position if inadvertently moved by a user climbing the ladder.

The bottom folding step 506 is pivotally coupled to a third step bracket 528. The third step bracket 528 is connected to the third telescoping post segment 526. A third tension spring 530 couples the bottom folding step 506 and the third step bracket 528, biasing the bottom folding step 506 in the folded position. The bottom folding step 506 further includes a third bearing interface 532. In the unfolded position, the third bearing interface 532 is in contact with a fourth telescoping post segment 534, supporting the moment force experienced by the third step bracket 528 and preventing the tension from the third tension spring 530 from pulling the bottom folding step 506 beneath the third telescoping post segment 526. Thus, in the unfolded position, the bottom folding step 506 provides a stable stepping surface that returns to the unfolded position if inadvertently moved by a user climbing the ladder.

FIG. 5B is a perspective view of the example top folding step 502 in a folded position. As the first telescoping post segment 510 collapses within an above telescoping post segment 536, a first cam 538 engages the follower 516. Engagement of the follower 516 and the first cam 538 causes the top folding step 502 to fold upwards, against the tension applied by the first tension spring 512. In the illustrated example of FIG. 5B, the first cam 538 is on the interface assembly 222. In other examples, the first cam 538 may be located on a different portion of the telescoping post 204, such as the above telescoping post segment 536. As the telescoping post 204 is extended, the follower 516 and the first cam 538 are disengaged, allowing the tension applied by the first tension spring 512 to unfold the step 502 automatically.

FIG. 5C is a front view of the example middle folding step 504 and bottom folding step 506 in a folded position. As the second, third, and fourth telescoping post segments 518, 526, 534 collapse within the telescoping post segments 212 that are above them, the second bearing interface 524 and the third bearing interface 532 are no longer in contact with any telescoping post segments 212 below their respective positions. As a result, the tension from the second tension spring 522 and the third tension spring 530 pull the middle folding step 504 and the bottom folding step 506 into the return cavity 312 of the bottom fixed step 220. In the illustrated example of FIGS. 5A-5C, the bottom fixed step 220 includes recesses 540. The top folding step 502, the middle folding step 504, and the bottom folding step 506 each include fins 542 (shown more clearly in FIG. 5B). The recesses 540 receive the fins 542 when the folding steps 504, 506 are in the folded position, allowing the folding steps 504, 506 to fold into the return cavity 312. When the telescoping post segments 212 are extended, they engage the second bearing interface 524 and the third bearing interface 532, causing the steps to return to the unfolded position. The bearing interfaces 524, 532 include second cams to enable smooth motion of the folding steps 504, 506 as the post segments 212 extend and collapse.

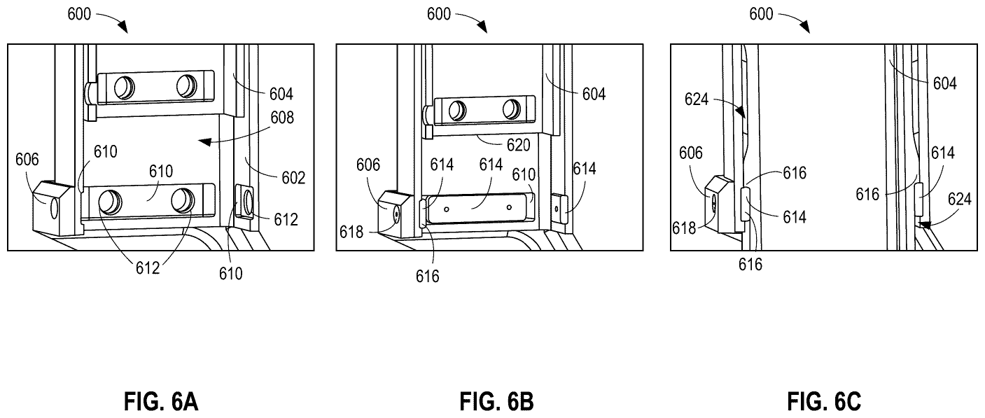

FIG. 6A is a perspective, cutaway view of a portion of an example telescoping post 600 that may be implemented by the example boarding ladder system 102. The example telescoping post 600 includes a first telescoping post segment 602, a second telescoping post segment 604, and a step bracket 606 to couple the first telescoping post segment 602. The second telescoping post segment 604 collapses within a cavity 608 defined by the first telescoping post segment 602. The first telescoping post segment 602 includes a plurality of recesses 610 on the interior surfaces of the telescoping post segment 602. In the illustrated example of FIG. 6A, the telescoping post segment 602 includes one recess 610 on each side of the telescoping post segment 602. In other examples, the telescoping post segment includes more than one recess 610 in a side of the telescoping post segment 610. In some examples, the telescoping post segment 602 includes a recess 610 in fewer than all of the sides of the telescoping post segment 602 (e.g., only three of the four sides of the example telescoping post segment 602). In some examples, the size, shape, position, and/or number of recesses 610 is different than in the example telescoping post 600. The example recesses 610 each include at least one bore (e.g., hole) 612. In other examples, fewer than all of the recesses 610 include a bore 612. In some examples, the size, shape, position, and/or number of bores 612 may be different than in the example telescoping post 600. The recesses 610 and the bores 612 serve as the interface for gland guides as discussed in connection with FIG. 6B.

In the illustrated example of FIG. 6A, the first telescoping post segment 602 and the second telescoping post segment 604 are square telescoping segments. The example first and second telescoping post segments 602, 604 have square cross-sections. In other examples, the first and second telescoping post segments 602, 604 have cross-sections that are circular, rectangular, triangular, or another geometric shape. In those examples, the size, shape, position, and/or number of recesses 610 and the size, shape, position, and/or number of bore holes 612 may be different than the example telescoping post 600.

FIG. 6B illustrates the example telescoping post 600 with gland guides 614 inserted into the recesses 610. The gland guides 614 include a base 616 and protrusions 618. The bases 616 are positioned partially in the recesses 610 and partially in the cavity 608. The protrusions 618 extend through the bores 612 and through the step bracket 606. Thus, the gland guides 614 provide a mounting interface for the step bracket 606 to be mounted to the first telescoping post segment 602. FIGS. 6A and 6B illustrate the second telescoping post 604 in an assembly position. Once the gland guides 614 are inserted, a bottom 620 of the second telescoping post segment 604 is drawn below the gland guides 614. In use, the bottom 620 of the second telescoping post segment 604 does not collapse above the gland guides 614. As such, the second telescoping post segment 604 and the recesses 610 trap the gland guides 614 in place.

FIG. 6C illustrates the example telescoping post 600 in a fully extended position. In the fully extended position, ledges (e.g., ridges, lips, protrusions, etc.) 622 of the second telescoping post segment 604 engage a portion of the gland guides 614 extending into the cavity 608. As discussed above, the second telescoping post segment 604 and the recesses 610 trap the gland guides 614 in place, preventing the gland guides from moving out of the recess, without the use of screws, bolts, or other like fastening methods. The ledges 622 and the gland guides 614 also serve as a guide for the second telescoping post segment 604 as it extends and collapses within the cavity 608. This allows for gaps 624 between the telescoping post segment 604 and the first telescoping post segment 602. As such, the gland guides 614 reduce wear on the interior of the first telescoping post segment 602 and the exterior of the second telescoping post segment 604. Thus, the gland guides serve as the primary wear interface of the telescoping post 600.

When a user climbs the telescoping post 600, the portion of the load experienced by the step bracket 606 is transferred to the gland guides 614 via the protrusions 618. Furthermore, the bases 616 of the gland guides 614 carry the loads from the ledges 622 of the second telescoping post segment 604. As such, the gland guides 614 also serve as the primary load introduction point of the telescoping post 600. This simplifies both manufacturing of the telescoping post 600 and distribution of the loads experienced by the telescoping post 600.

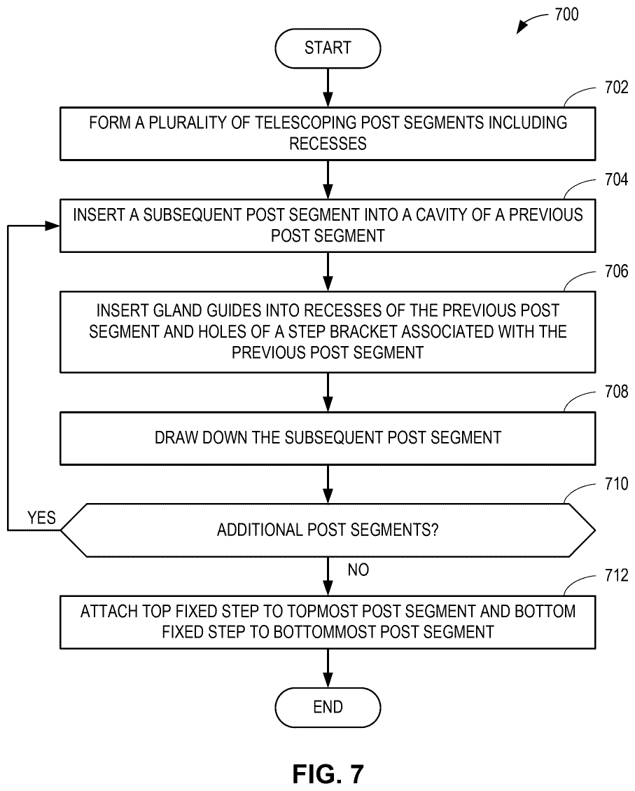

FIG. 7 is a flowchart representative of an example process 700 of manufacturing the telescoping posts to implement the example boarding ladder system 102. The example process 700 begins at block 702, at which a plurality of telescoping post segments 212 are formed with recesses 610. The recesses 610 are formed in interior surfaces of the plurality of telescoping post segments 212. In some examples, forming the plurality of telescoping post segments 212 includes extruding a plurality of square tubing and machining or otherwise forming an outer dimension of the tubing to create ledges 622. In some examples, forming the plurality of post segments 212 includes forming bores 612 in interior surfaces of the plurality of telescoping post segments 212. For example, the bores 612 may be formed in the recesses 610. At block 704, a subsequent post segment (e.g., second telescoping post segment 604) is inserted into a cavity of a previous post segment (e.g., first telescoping post segment 602). The subsequent post segment is inserted such that the bottom of the subsequent post segment is positioned above the recesses 610 of the previous post segment. For example, the subsequent post segment may be inserted to the position of second telescoping post segment 604 in FIGS. 6A and 6B. At block 706, gland guides 614 are inserted into the recesses 610 of the previous post segment and holes of a step bracket 508, 520, 528, 606. Protrusions 618 of the gland guides 614 extend through the bores 512 and into the holes of the step bracket 508, 520, 528, 606. At block 708, the subsequent post is drawn down. At block 710, whether an additional post segment 212 is to be inserted is determined. If an additional post segment is to be inserted, the example process 700 returns to block 704 at which the additional post segment is inserted. If there are no additional post segments to be inserted, the process 700 continues to block 712, where a top fixed step 214 is fixed to a topmost post segment 316 and a bottom fixed step 220 is fixed to a bottommost telescoping post segment.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third. ” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

From the foregoing, it will be appreciated that example systems, apparatus, articles of manufacture, and methods have been disclosed that provide for a boarding ladder than is horizontally stowed and vertically deployed. Example boarding ladder systems disclosed herein include a fixed step that extends above the compartment when the telescoping post is in the vertical orientation. Example boarding ladder systems disclosed herein include steps that automatically unfold in response to extension of the telescoping post and automatically fold in response to collapsing of the telescoping post. Disclosed systems, apparatus, articles of manufacture, and methods improve special efficiency of aircraft design by limiting the amount of vertical space, horizontal space, and internal depth required for storage of a boarding ladder.

Although each boarding ladder system disclosed above has certain features, it should be understood that it is not necessary for a particular feature of one example boarding ladder system to be used exclusively with that example boarding ladder system. Instead, any of the features described above and/or depicted in the drawings can be combined with any of the example boarding ladder systems, in addition to or in substitution for any of the other features of those example boarding ladder systems. One example boarding ladder system's features are not mutually exclusive to another example boarding ladder system's features. Instead, the scope of this disclosure encompasses any combination of any of the features.

Example boarding ladder systems are disclosed herein. Further examples and combinations thereof include the following:

Example 1 includes a boarding ladder of an aircraft, the boarding ladder including a linkage including a first support, a platform, and a second support, the linkage rotatable in a first plane, a lateral stop arm of the first support to engage a catch of the platform in a deployed position, engagement of the lateral stop arm and the catch to restrict rotation of the linkage in a first direction of rotation, and a post pivotally coupled to the platform, the post rotatable in a second plane with respect to the platform, the second plane different than the first plane, the post including a fastener enabling coupling of the post and the first support in the deployed position.

Example 2 includes the boarding ladder as defined in Example 1, wherein the post is pivotally coupled to the platform at a first end of a first portion of the post, the post including a step at a second end of the first portion of the post, the second end of the post extending above a compartment of the boarding ladder in the deployed position.

Example 3 includes the boarding ladder as defined in Example 1 or Example 2, wherein the post includes a pawl to engage the lateral stop arm in the deployed position, engagement of the pawl and the lateral stop arm to restrict rotation of the linkage in a second direction of rotation, the second direction of rotation opposite the first direction of rotation.

Example 4 includes the boarding ladder as defined in any of Examples 1-3, wherein the platform forms a step of the boarding ladder.

Example 5 includes the boarding ladder as defined in any of Examples 1-4, wherein the post is a telescoping post, the telescoping post including a plurality of telescoping post segments and a plurality of folding steps, folding steps of the plurality of folding steps coupled to respective telescoping post segments of the plurality of telescoping post segments via a plurality of step brackets.

Example 6 includes the boarding ladder as defined in any of Examples 1-5, wherein the telescoping post further includes a bottom fixed step coupled to a bottommost telescoping post segment of the plurality of telescoping post segments, the bottom fixed step including a return cavity to receive at least one folding step of the plurality of folding steps in a stowed position.

Example 7 includes the boarding ladder as defined in any of Examples 1-6, further including a draw latch coupled to a topmost telescoping post segment of the plurality of telescoping post segments, the draw latch to retain the at least one folding step in the return cavity in the stowed position.

Example 8 includes the boarding ladder as defined in any of Examples 1-7, wherein the plurality of folding steps includes a first folding step, the first folding step including a first tension spring to bias the first folding step into an unfolded position.

Example 9 includes the boarding ladder as defined in any of Examples 1-8, wherein the first folding step includes a follower and the telescoping post including a cam, the cam to contact the follower when the telescoping post is collapsed, causing the first folding step to move to a folded position against the first tension spring.

Example 10 includes the boarding ladder as defined in any of Examples 1-9, wherein the plurality of folding steps includes a second folding step, the second folding step including a second tension spring to bias the second folding step to a folded position.

Example 11 includes the boarding ladder as defined in any of Examples 1-10, wherein the second folding step includes a bearing interface, the telescoping post segments to engage the bearing interface when the telescoping post is in an extended position, moving the second folding step to an unfolded position.

Example 12 includes an aircraft including a compartment to retain a boarding ladder, and a boarding ladder including a support assembly rotatable between a first position and a second position, the support assembly contained within the compartment in the first position, a portion of the support assembly extending outside of the compartment to an exterior of the aircraft in the second position, a first support of the support assembly including a lateral stop arm to engage a catch of a platform of the support assembly in the second position, and a post pivotally coupled to the platform, the post having a first state and a second state, the post oriented horizontally in the first state, the post oriented vertically in the second state, and the post fastened to a support of the support assembly in the second state.

Example 13 includes the aircraft as defined in Example 12, wherein the post includes a ledge to engage the lateral stop arm when the post is in the second state, the ledge and the catch to restrict rotation of the support assembly when the support assembly is in the second position and the post is in the second state.

Example 14 includes the aircraft as defined in Example 12 or Example 13, wherein the post is moveable from the second state to a third state, the post including a plurality of nesting post segments, the plurality of nesting post segments extended in the third state and collapsed in the first and second states.

Example 15 includes the aircraft as defined in any of Examples 12-14, wherein the post includes a plurality of folding steps coupled to the plurality of nesting post segments via a plurality of step brackets, and a gland guide, a first nesting post segment of the plurality of nesting post segments including a recess, the gland guide partially inside the recess and extending into a cavity of the first nesting post segment.

Example 16 includes the aircraft as defined in any of Examples 12-15, wherein the plurality of nesting post segments includes a second nesting post segment, the gland guide retained in the recess by the first and second nesting post segments, a portion of the second nesting post segment in the cavity in the first and second states, the portion outside of the cavity in the third state.

Example 17 includes the aircraft as defined in any of Examples 12-16, wherein a first step bracket of the plurality of step brackets is coupled to the gland guide.

Example 18 includes a boarding ladder for a vehicle, the boarding ladder including a support assembly to provide a first motion away from a surface of the vehicle, the support assembly including a first support including a lateral stop arm, and a platform coupled to the first support, the platform including a catch, the lateral stop arm to engage the catch at an end of the first motion, and a post coupled to the platform, the post to provide a second motion to rotate the post from a horizontal orientation to a vertical orientation.

Example 19 includes the aircraft as defined in Example 18, wherein the post is moveable between a collapsed position and an extended position, the post including a plurality of folding steps, the plurality of folding steps folded in the collapsed position and automatically unfolded in the extended position.

Example 20 includes the aircraft as defined in Example 18 or Example 19, wherein the post includes a first fixed step extending above a compartment of the vehicle when the post is in the vertical orientation, the compartment to retain the boarding ladder in a stowed position and a second fixed step coupled to a bottom of the post, and wherein the platform includes a third fixed step.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A boarding ladder of an aircraft, the boarding ladder comprising:
a linkage including a first support, a platform, and a second support, the linkage rotatable in a first plane, a lateral stop arm of the first support to engage a catch of the platform in a deployed position, engagement of the lateral stop arm and the catch to restrict rotation of the linkage in a first direction of rotation; and
a post pivotally coupled to the platform, the post rotatable in a second plane with respect to the platform, the second plane different than the first plane, the post including a fastener enabling coupling of the post and the first support in the deployed position.

2. The boarding ladder of claim 1, wherein the post is pivotally coupled to the platform at a first end of a first portion of the post, the post including a step at a second end of the first portion of the post, the second end of the post extending above a compartment of the boarding ladder in the deployed position.

3. The boarding ladder of claim 1, wherein the post includes a pawl to engage the lateral stop arm in the deployed position, engagement of the pawl and the lateral stop arm to restrict rotation of the linkage in a second direction of rotation, the second direction of rotation opposite the first direction of rotation.

4. The boarding ladder of claim 1, wherein the platform forms a step of the boarding ladder.

5. The boarding ladder of claim 1, wherein the post is a telescoping post, the telescoping post including a plurality of telescoping post segments and a plurality of folding steps, folding steps of the plurality of folding steps coupled to respective telescoping post segments of the plurality of telescoping post segments via a plurality of step brackets.

6. The boarding ladder of claim 5, wherein the telescoping post further includes a bottom fixed step coupled to a bottommost telescoping post segment of the plurality of telescoping post segments, the bottom fixed step including a return cavity to receive at least one folding step of the plurality of folding steps in a stowed position.

7. The boarding ladder of claim 6, further including a draw latch coupled to a topmost telescoping post segment of the plurality of telescoping post segments, the draw latch to retain the at least one folding step in the return cavity in the stowed position.

8. The boarding ladder of claim 5, wherein the plurality of folding steps includes a first folding step, the first folding step including a first tension spring to bias the first folding step into an unfolded position.

9. The boarding ladder of claim 8, wherein the first folding step includes a follower, the telescoping post including a cam, the cam to contact the follower when the telescoping post is collapsed, causing the first folding step to move to a folded position against the first tension spring.

10. The boarding ladder of claim 5, wherein the plurality of folding steps includes a second folding step, the second folding step including a second tension spring to bias the second folding step to a folded position.

11. The boarding ladder of claim 10, wherein the second folding step includes a bearing interface, the telescoping post segments to engage the bearing interface when the telescoping post is in an extended position, moving the second folding step to an unfolded position.

12. An aircraft comprising:
a compartment to retain a boarding ladder; and
a boarding ladder including:
a support assembly rotatable between a first position and a second position, the support assembly contained within the compartment in the first position, a portion of the support assembly extending outside of the compartment to an exterior of the aircraft in the second position, a first support of the support assembly including a lateral stop arm to engage a catch of a platform of the support assembly in the second position; and
a post pivotally coupled to the platform, the post having a first state and a second state, the post oriented horizontally in the first state, the post oriented vertically in the second state, and the post fastened to a support of the support assembly in the second state.

13. The aircraft of claim 12, wherein the post includes a ledge to engage the lateral stop arm when the post is in the second state, the ledge and the catch to restrict rotation of the support assembly when the support assembly is in the second position and the post is in the second state.

14. The aircraft of claim 12, wherein the post is moveable from the second state to a third state, the post including a plurality of nesting post segments, the plurality of nesting post segments extended in the third state and collapsed in the first and second states.

15. The aircraft of claim 14, wherein the post includes:
a plurality of folding steps coupled to the plurality of nesting post segments via a plurality of step brackets; and
a gland guide, a first nesting post segment of the plurality of nesting post segments including a recess, the gland guide partially inside the recess and extending into a cavity of the first nesting post segment.

16. The aircraft of claim 15, wherein the plurality of nesting post segments includes a second nesting post segment, the gland guide retained in the recess by the first and second nesting post segments, a portion of the second nesting post segment in the cavity in the first and second states, the portion outside of the cavity in the third state.

17. The aircraft of claim 15, wherein a first step bracket of the plurality of step brackets is coupled to the gland guide.

18. A boarding ladder for a vehicle, the boarding ladder comprising:
a support assembly to provide a first motion away from a surface of the vehicle, the support assembly including:
a first support including a lateral stop arm; and
a platform coupled to the first support, the platform including a catch, the lateral stop arm to engage the catch at an end of the first motion; and
a post coupled to the platform, the post to provide a second motion to rotate the post from a horizontal orientation to a vertical orientation.

19. The vehicle of claim 18, wherein the post is moveable between a collapsed position and an extended position, the post including a plurality of folding steps, the plurality of folding steps folded in the collapsed position and automatically unfolded in the extended position.

20. The vehicle of claim 18, wherein the post includes:
a first fixed step extending above a compartment of the vehicle when the post is in the vertical orientation, the compartment to retain the boarding ladder in a stowed position; and
a second fixed step coupled to a bottom of the post, and wherein the platform includes a third fixed step.
